(19) United States
(12) Patent Application Publication
(10) Pub. No.: US 2016/0282950 A1
(43) Pub. Date: Sep. 29, 2016

(54) ELECTRONIC DEVICE, METHOD, AND COMPUTER-READABLE MEDIUM FOR MANAGING AND CONTROLLING GRAPHICAL USER INTERFACES

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-HUA HSU, New Taipei (TW); SHI-QIANG ZHU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/807,204

(22) Filed: Jul. 23, 2015

(30) Foreign Application Priority Data
Mar. 27, 2015 (CN) 201510138813.1

(51) Int. Cl. G06F 3/01; G06F 3/0482; G06F 3/0481

(52) U.S. Cl. CPC G06F 3/017; G06F 3/04817; G06F 3/0482

(57) ABSTRACT

A method for managing and controlling graphic user interface starts with an initial graphical user interface being displayed on a display device. When a request is made in a particular manner, it is determined that such request requires an update of the initial graphical user interface, and a substitute graphic user interface is generated. The substitute graphic user interface is a scaled-down replica of the initial graphical user interface. The substitute graphic user interface is displayed on the display device to replace the initial graphic user interface and so as to have the same functionality as the initial graphic user interface.

### CROSS-REFERENCE TO RELATED APPLICATIONS

This application claims priority to Chinese Patent Application No. 201510138813.1 filed on Mar. 27, 2015, the contents of which are incorporated by reference herein.

### FIELD

The subject matter herein generally relates to management of graphic user interfaces.

### BACKGROUND

Generally, electronic devices each have a graphical user interface. The graphical user interface includes many objects such as application icons, function icons, and the like. Display screens on many devices have increased in size while the thickness and remainder of the device has decreased.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device and function modules of a graphical user interface control system.

FIG. 2 is a diagrammatic view of one embodiment of an initial graphical user interface displayed on the electronic device in FIG. 1.

FIG. 3 is a diagrammatic view of one embodiment of the electronic device in FIG. 2 in an inclined state.

FIG. 4 is a diagrammatic view of one embodiment of a substitute graphical user interface displayed on the electronic device in FIG. 1.

FIG. 5 is a flowchart of one embodiment of a method for controlling graphical user interfaces.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

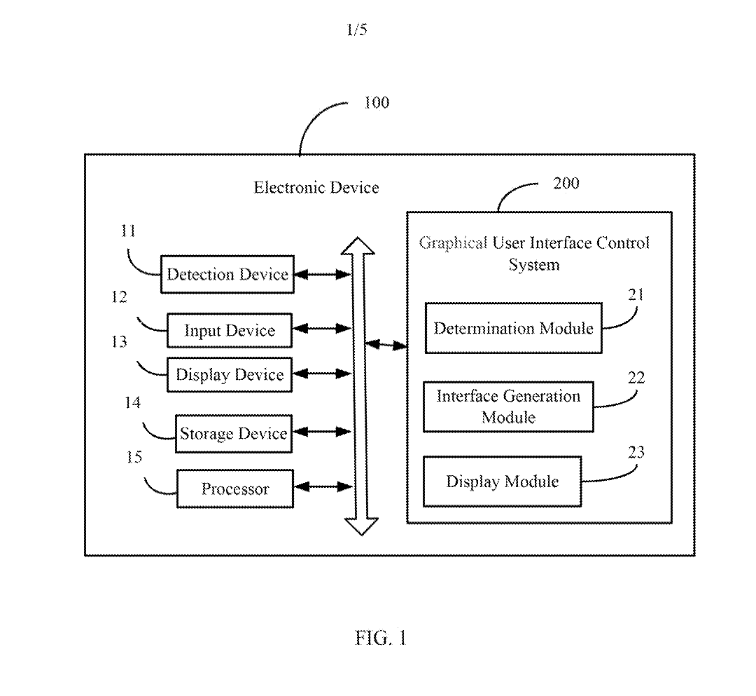

FIG. 1 shows one embodiment of functional modules of a graphical user interface control system. The graphical user interface control system 200 is installed and runs in an apparatus, for example an electronic device 100. In at least one embodiment as shown in FIG. 1, the electronic device 100 includes, but is not limited to, a detection device 11, an input device 12, a display device 13, a storage device 14, and at least one processor 105. The electronic device 100 can be a tablet computer, a notebook computer, a smart phone, a personal digital assistant (PDA), or other suitable electronic device. FIG. 1 illustrates only one example of the electronic device; other examples can include more or fewer components than illustrated, or have a different configuration of the various components in other embodiments.

The graphical user interface control system 200 can display an initial graphical user interface on a display device. The system 200 can determine that a request to update the initial graphical user interface is generated. The graphical user interface control system 200 further generates a substitute graphic user interface. The substitute graphic user interface is smaller-scale presentation of the initial graphical user interface. Then, the graphical user interface control system 200 displays the substitute graphic user interface on the display device to replace the initial graphical user interface. A user of the electronic device can use the fingers of one hand to operate the small scale icons on the substitute graphic user interface.

In at least one embodiment, the storage device 14 can include various types of non-transitory computer-readable storage mediums. For example, the storage device 14 can be an internal storage system, such as a flash memory, a random access memory (RAM) for temporary storage of information, and/or a read-only memory (ROM) for permanent storage of information. The storage device 14 can also be an external storage system, such as a hard disk, a storage card, or a data storage medium. The at least one processor 15 can be a central processing unit (CPU), a microprocessor, or other data processor chip that performs functions of the graphical user interface control system 200 in the electronic device 100. The display device 13 can display images and videos, and the input device 14 can be a mouse, a keyboard, or a touch panel.

The detection device 11 can detect a movement of the electronic device 100 and generate a first electrical signal according to the detected movement. In one embodiment, the detection device 11 is a gyroscope. The gyroscope can detect a direction of movement and any inclination angle of the electronic device 100. The electrical signal includes information of the direction of movement and an inclination angle. In another embodiment, the detection device 11 is an acceleration sensor. The acceleration sensor can detect a direction of movement and a moving distance of the electronic device 100.

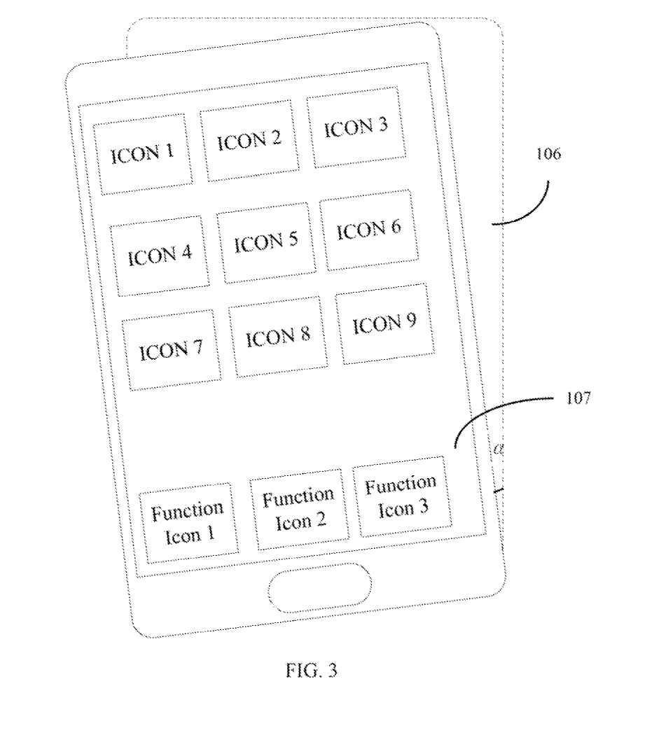

The inclination angle referred to in this application is the angle between the initial orientation of the electronic device 100 and an inclination resulting from a movement. FIG. 3 illustrates the electronic device 100 in an inclined state. The electronic device 100 was in a location 106 before being inclined. When the electronic device 100 is moved, electronic device 100 is as a result in a location 107. The inclination angle is the angle α between the locations 106 and 107.

The input device 12 can generate a second electrical signal in response to an operation applied on it. The input device 12 can include physically depressible keys (not shown in FIGS.), or touch buttons, items or icon keys displayed on the display device 13, or a combination of those.

In at least one embodiment, the graphical user interface control system 200 can include a determination module 21, an interface generation module 22, and a display module 23. The function modules 21-23 can include computerized codes in the form of one or more programs, which are stored in the storage device 14. The at least one processor 15 executes the computerized codes to provide functions of the function modules 21-23.

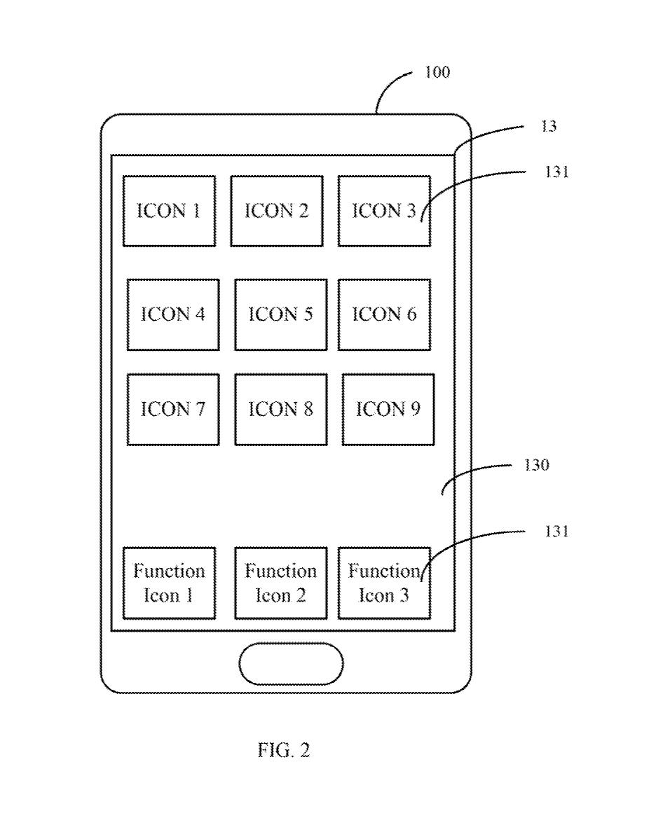

The display module 23 can display an initial graphical user interface 130 on the display device 13. FIG. 2 illustrates the initial graphical user interface 130. In the embodiment, the initial graphical user interface 130 includes a number of initial icons 131. The initial icons 131 includes application icons associated with application programs installed on the electronic device 100, and function icons.

The determination module 21 can determine that a request to update the initial graphical user interface is generated. In the embodiment, the determination module 21 determines that the request to update the initial graphical user interface is generated when the first signal is generated by the detection device 11 in response to a particular movement of the electronic device 100 and the second signal is generated by the input device 12 in response to a particular input operation. In the embodiment, the particular movement is the electronic device in a tilting or tilted state. The particular operation on the input device 12 is a long press operation. The time period of a long press operation on the input device 12 equals or is longer than a preset time period. When the input device 12 receives a press for a long time, and the electronic device 100 is tilted, the determination module 21 determines that a request to update the initial graphic user interface is generated.

In an embodiment, as shown in FIG. 3, the determination module 21 obtains an inclination angle of the electronic device 100 from the signal generated by the detection device 100, and determines whether the corresponding inclination angle is larger than a preset angle. When the inclination angle is larger than the preset angle, the determination module 21 determines whether the resulting inclination angle is further changed within a second preset time period. When the resulting inclination angle is changed and the changed resulting inclination angle is smaller than the preset angle, the determination module 21 determines the electronic device 100 is in the process of being tilted.

In another embodiment, the determination module 21 can determine whether the electronic device 100 is being tilted, and further determine whether the time period of a long press on the input device 12 equals or is longer than a preset time period when the electronic device 100 is being tilted. When the time period of the long press applied on the input device 12 equals or is longer than a preset time period, the determination module 21 determines that the request to update the initial graphic user interface is generated.

The interface generation module 22 can generate a substitute graphic user interface. In the embodiment, the interface generation module 22 generates the substitute graphic user interface based on a direction of movement of the electronic device 100 and the initial graphic user interface 130.

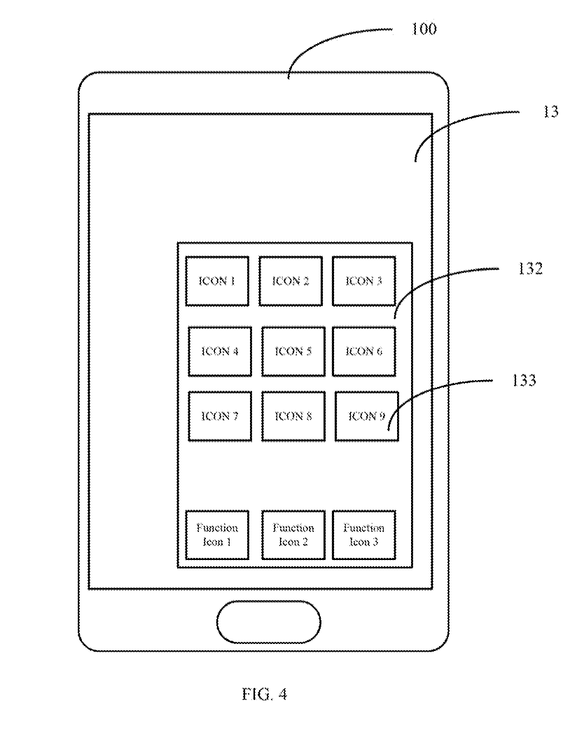

FIG. 4 illustrates the substitute graphic user interface. In one embodiment, the substitute graphic user interface 132 is a scaled-down interface of the initial graphical user interface 130. The interface generation module 22 generates the substitute graphic user interface 132 by minimizing the initial graphic user interface 130 according to a preset minimizing ratio. The substitute graphic user interface 132 includes a number of small scale icons 133. The small scale icons 133 are the initial icons 131 reduced in size. The small scale icons 133 are generated by minimizing the initial icons 131 according to the preset minimizing ratio. The electronic device 100 performs functions in response to operations on the icons whether the icons are small or large. For example, an application program associated with an icon 133 operates when a user clicks the initial icon 131 or the small scale icon 133.

The display module 23 can display the substitute graphic user interface 132 on the display device 13. Thus, the substitute graphic user interface 132 replaces the initial graphic user interface 130 on the display device 13.

In one embodiment, when the electronic device 100 is inclined toward left side, the display module 23 displays the substitute graphic user interface on a bottom right corner of the display device 13. When the electronic device 100 is inclined toward right side, the display module 23 displays the substitute graphic user interface on a bottom left corner of the display device 13. In an alternative embodiment, when the electronic device 100 is inclined toward left side, the display module 23 displays the substitute graphic user interface on the bottom left corner of the display device 13. When the electronic device 100 is inclined toward right side, the display module 23 displays the substitute graphic user interface on the bottom right corner of the display device 13.

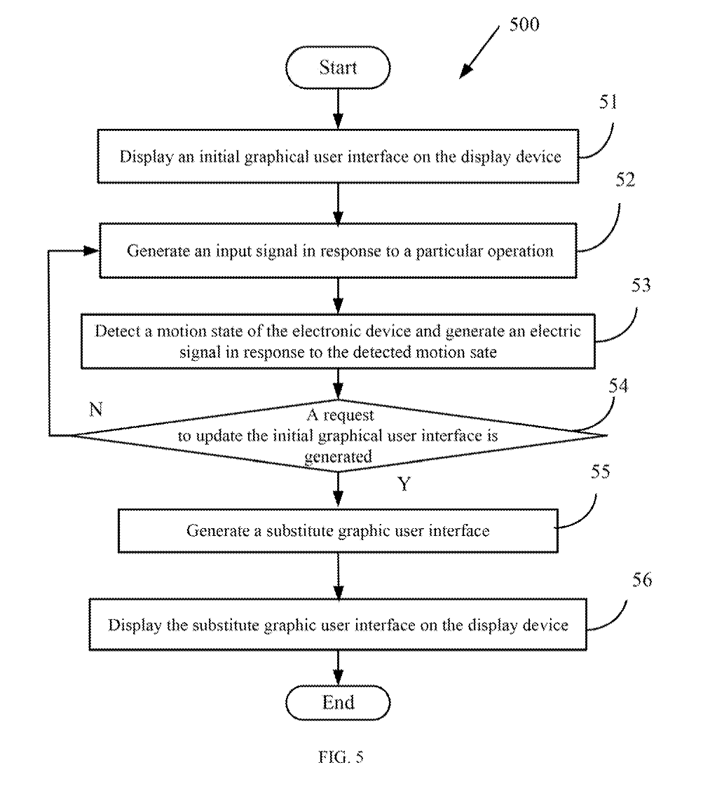

FIG. 5 is a flowchart of one embodiment of a method for controlling a graphical user interface. The example method 500 is provided by way of example, as there are a variety of ways to carry out the method. The method 500 described below can be carried out using the configurations illustrated in FIGS. 1-4, for example, and various elements of these figures are referenced in explaining example method 500. Each block shown in FIG. 5 represents one or more processes, methods, or subroutines, carried out in the exemplary method 500. Furthermore, the illustrated order of blocks is by example only and the order of the blocks can change. The exemplary method 500 can begin at block 51. Depending on the embodiment, additional steps can be added, others removed, and the ordering of the steps can be changed.

At block 51, the display module displays an initial graphical user interface on the display device.

In the embodiment, the initial graphical user interface 130 includes a number of initial icons including application icons 131 associated with application programs installed on the electronic device 100, and function icons 131. When a user applies an operation on the application icon 131 such as double-click, the application associated with the application icon 131 begins to be run. When a user applies an operation on the function icon 131, such a touch, the initial graphical user interface 130 implements a function represented by the function icon 131.

At block 52, the input device generates a second signal in response to a particular input operation.

At block 53, the detection device detects a movement of the electronic device and generates a first signal in response to the detected movement.

At block 54, the determination module determines whether a request to update the initial graphical user interface is generated. If yes, the process goes to block 55; if no, the process goes back to block 52.

In the embodiment, the determination module 21 determines that the request to update the initial graphical user interface is generated when the first signal is generated by the detection device 11 in response to a tilting of the electronic device 100, and the second signal is generated by the input device 12 in response to a long press operation.

At block 55, the interface generation module generates a substitute graphic user interface. The substitute graphic user interface is a scaled-down replica of the initial graphical user interface.

At block 56, the display module displays the substitute graphic user interface to replace the initial graphic user interface on the display device.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for managing and controlling graphic user interfaces being executed by at least one processor of an electronic device, the method comprising:
displaying an initial graphical user interface on a display device;
determining whether a request to update the initial graphical user interface is received;
generating a substitute graphic user interface when the request is received, wherein the substitute graphic user interface is scaled-down relative to the initial graphical user interface; and
displaying the generated substitute graphic user interface in place of the initial graphical user interface on the display device.

2. The method according to claim 1, wherein the request is generated when a detection device of the electronic device generates a first signal in response to a movement of the electronic device and an input device of the electronic device generates a second signal in response to an operation applied on the input device.

3. The method according to claim 2, wherein the substitute graphic user interface is generated based on a direction of movement of the electronic device and the initial graphic user interface.

4. The method according to claim 2, wherein the request is generated when the electronic device is tilted and the input device receives a long press operation.

5. The method according to claim 4, further comprising:
obtaining an inclination angle of the electronic device;
determining whether the inclination angle is larger than a preset angle
determining whether the resulting inclination angle is further changed within a second preset time period when the inclination angle is larger than the preset angle, and whether the changed resulting inclination angle is smaller than the preset angle; and
determining the electronic device is in the state of being tilted when the resulting inclination angle is changed and the changed resulting inclination angle is smaller than the preset angle.

6. The method according to claim 5, wherein the initial graphic user interface comprises a plurality of initial icons, the substitute graphic user interface is generated by minimizing the initial graphic user interface according to a preset minimizing ratio, the substitute graphic user interface comprises small scale icons, the small scale icons are the initial icons reduced in size, the small scale icons are generated by minimizing the initial icons according to a preset minimizing ratio.

7. An electronic device, comprising:
a display device;
at least one processor; and
a storage device that stores one or more programs which, when executed by the at least one processor, cause the processor to:
display an initial graphical user interface on the display device;
determine whether a request to update the initial graphical user interface is received;
generate a substitute graphic user interface when the request is received, wherein the substitute graphic user interface is scaled-down relative to the initial graphical user interface;
display the substitute graphic user interface to in place of the initial graphical user interface on the display device.

8. The electronic device according to claim 7, wherein the request is generated when a detection device of the electronic device generates a first signal in response to a movement state of the electronic device and an input device of the electronic device generates a second signal in response to an operation applied on the input device.

9. The electronic device according to claim 8, wherein the substitute graphic user interface is generated based on a direction of movement of the electronic device and the initial graphic user interface.

10. The electronic device according to claim 8, wherein the request is generated when the electronic device is tilted and the input device receives a long press operation.

11. The electronic device according to claim 10, the processor is further caused to:
obtain an inclination angle of the electronic device;
determine whether the inclination angle is larger than a preset angle;
determine whether the inclination angle is further changed within a second preset time period when the inclination angle is larger than the preset angle, and whether the changed resulting inclination angle is smaller than the preset angle; and
determine the electronic device is in the state of being tilted when the resulting inclination angle is changed and the changed resulting inclination angle is smaller than the preset angle.

12. The electronic device according to claim 11, wherein the initial graphic user interface comprises a plurality of initial icons, the substitute graphic user interface is generated by minimizing the initial graphic user interface according to a preset minimizing ratio, the substitute graphic user interface comprises small scale icons, the small scale icons are the initial icons reduced in size, the small scale icons are generated by minimizing the initial icons according to the preset minimizing ratio.

13. A non-transitory storage medium having stored thereon instructions that, when executed by a processor of an electronic device, causes the processor to perform a method for managing and controlling graphic user interfaces, wherein the method comprises:
displaying an initial graphical user interface on a display device;
determining whether a request to update the initial graphical user interface is received;
generating a substitute graphic user interface when the request is received, wherein the substitute graphic user interface is scaled-down relative to the initial graphical user interface;
displaying the generated substitute graphic user interface in place of the initial graphical user interface on the display device.

14. The non-transitory storage medium according to claim 13, wherein the request is generated when a detection device of the electronic device generates a first signal in response to a movement of the electronic device and an input device of the electronic device generates a second signal in response to an operation applied on the input device.

15. The non-transitory storage medium according to claim 14, wherein the substitute graphic user interface is generated based on a direction of movement of the electronic device and the initial graphic user interface.

16. The non-transitory storage medium according to claim 15, wherein the request is generated when the electronic device is tilted and the input device receives a long press operation.

17. The non-transitory storage medium according to claim 15, further comprising:
obtaining an inclination angle of the electronic device;
determining whether the inclination angle is larger than a preset angle;
determining whether the resulting inclination angle is further changed within a second preset time period when the inclination angle is larger than the preset angle, and whether the changed resulting inclination angle is smaller than the preset angle; and
determining the electronic device is in the state of being tilted when the resulting inclination angle is changed and the changed resulting inclination angle is smaller than the preset angle.

18. The non-transitory storage medium according to claim 17, wherein the initial graphic user interface comprises a plurality of initial icons, the substitute graphic user interface is generated by minimizing the initial graphic user interface according to a preset minimizing ratio, the substitute graphic user interface comprises small scale icons, the small scale icons are the initial icons reduced in size, the small scale icons are generated by minimizing the initial icons according to the preset minimizing ratio.

19. The non-transitory storage medium according to claim 18, wherein the place of the substitute graphic user interface displayed on the display device is associated with an inclined direction of the electronic device.

20. The non-transitory storage medium according to claim 18, wherein the substitute graphic user interface is displayed on a bottom right corner of the display device when the electronic device is inclined toward left side, and the substitute graphic user interface is displayed on a bottom left corner of the display device when the electronic device is inclined toward right side.
